(19) United States
(12) Patent Application Publication
(10) Pub. No.: US 2003/0153675 A1
(43) Pub. Date: Aug. 14, 2003

(54) Salt-free aqueous dispersions of water soluble (co) polymers based on cationic monomrs, method for making same and uses thereof

(76) Inventors: Alain Riondel, Fobach (FR); Denis Tembou N'Zudie, Serquigny (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/181,821

(22) PCT Filed: Jan. 19, 2001
(86) PCT No.: PCT/FR01/00183

(30) Foreign Application Priority Data
Jan. 24, 2000 (FR) 00-00833

(51) Int. Cl. C08L 41/00

(52) U.S. Cl. 524/814; 524/815; 524/816

(57) ABSTRACT

The invention concerns a salt-free aqueous dispersion of a water soluble dispersion obtained from a composition of monomers comprising, for 100 mole parts, 0.5 to 99.5 mole parts of at least a monomer (I), wherein R¹=H or —CH₃; R²=—CH₃; —C₂H₅; C₃H₇ or —C₄H₉; and the compound (I) is optionally quaternized on one of the nitrogen atoms, which is symbolised by the fact that the R³'s, X⁻ and ⁺ associated with said nitrogen are between square brackets; when compound (I) is quaternized on a single nitrogen, R³ and X⁻ represent the following: (1) R³=—CH₂—C₆H₅; and X⁻=Cl⁻ or CH₃OSO⁻; or (2) R³=—(CH₂)ₚCH₃ with p an integer from 3 to 11; and X⁻=Br⁻ or I⁻; when compound (I) is quaternized on both nitrogen atoms, both X⁻ can be identical or different and both R³, can be identical or different, in which case (3) R³=—CH₃C₆H₅; and X⁻=Cl⁻; and (4) R³=—(CH₂)ₚCH₃ with p an integer from 3 to 11; and X=Br⁻ or I⁻; (5) among compounds (I) quaternized on both nitrogen atoms and having both R³ different, if one of the R³=—CH₃, —C₂H₅ or C₃H₇; and X⁻=Cl⁻ or CH₃OSO⁻, the other=—CH₂C₆C₅, the associated X⁻ representing Cl⁻, or represents —(CH₂)ₚCH₃ with p an integer from 3 to 11, the associated X⁻ representing Br⁻ or I⁻.

The present invention relates to salt-free aqueous dispersions of water-soluble copolymers based on cationic monomers, to the preparation of these dispersions and to their applications.

Some of these cationic monomers are novel, their synthesis forming the subject matter of a French patent application filed today on behalf of the Applicant Company and having the title “Novel monomers comprising quaternary amino groups, their process of manufacture and the novel (co)polymers obtained from these novel monomers”. This novel manufacturing process also applies to known monomers, in accordance with a patent application also filed today on behalf of the Applicant Company.

Water-soluble polymers are used for various applications and in particular as flocculants for the treatment of municipal, waste and industrial water, the dehydration of the sludges generated, as thickeners and flow treatment agents. It is well known that aqueous systems of such water-soluble polymers with a high solids content are gelatinous and exhibit very high viscosities, which make them difficult to handle and to store. The problem posed to a person skilled in the art is the production of such aqueous systems but ones having both a high solids content and a low viscosity.

Conventional processes for the synthesis of these polymers comprise solution, reverse suspension and reverse emulsion polymerization. Solution polymerization and reverse suspension polymerization result in products in the powder state which exhibit the disadvantage of generating dust when used, of dissolving with difficulty in water and of not being able to form aqueous solutions of polymers with a high concentration which can be easily handled. In addition to this inconvenient implementation, which is specific to the pulverulent state of the product, these two processes are disadvantageous in terms of production efficiency, first because of the low concentration of monomer used during the polymerization and, secondly, because of the drying and/or milling stage, leading to an increase in the cycle time and an additional energy consumption cost. The reverse emulsion process, which has been known for about two decades, for its part results in a product having a contaminating organic solvent.

To overcome these disadvantages, a novel polymerization technique has been developed which results in aqueous dispersions of water-soluble polymers, the novel feature of which is based on the presentation, that is to say are devoid of contaminating solvent, do not generate dust, are rapidly dissolved in water, have a low viscosity at a high level of polymer and are ready to use. On the other hand, this technology requires the development of polymer dispersants suited to the stability of the polymer dispersed in a saline or nonsaline medium.

Some authors have prepared cationic or nonionic water-soluble polymers by polymerization of water-soluble monomers in the presence of a polymer dispersant of low mass. European patent EP-B-170 394 discloses a dispersion of particles of polymer gel with a size of greater than 20 μm in a solution of poly(sodium acrylic) or poly(diallyldimethylammonium chloride) dispersant. However, this product exhibits the disadvantage of having a high viscosity after a long period of storage, it being possible for the viscosity to be reduced only after shearing or stirring.

European patent applications EP-A-183 466 and EP-A-525 751, U.S. Pat. No. 4,929,655 and U.S. Pat. No. 5,006,590, and European patent application EP-A-657 478 provide for the case of precipitating polymerization in a saline medium of water-soluble monomers, the polymer of which precipitates in the form of particles and then is dispersed by means of stirring and is stabilized by polymer dispersants of low mass, which for their part are soluble in a saline medium. Furthermore, these particles are difficult to stabilize because of their large size (2-50 μm).

As regards aqueous dispersions comprising salts, the problem which is posed to a person skilled in the art comprises:

(1) the development of polymer dispersants which are soluble in a saline aqueous medium and which provide for good stability of the particles; and

(2) the development of water-soluble comonomers which make possible the manufacture of copolymers which are insoluble in an aqueous solution of salts, to make possible, by precipitation, the formation of the particles and, consequently, the “water/water emulsion” polymer dispersion.

As regards the dispersant, two approaches can be envisaged to achieve this objective of stabilization: first, by viscosifying the continuous phase using the associative effects contributed by the dispersant, to prevent the sedimentation of the particles, and, secondly, by promoting effective adsorption of the dispersant at the surface of the particles for better effectiveness as protective colloid, to prevent the coalescence of the particles. In the latter case, the hydrophobic units present in the structure of the dispersant can contribute strongly thereto. These dispersants have to have low masses, to provide for their solubility in a saline aqueous medium, and must have cationic functional groups necessary for the flocculation. Typical dispersants of these polymerizations are poly(diallyldimethylammonium chloride) or the diallyldimethylammonium chloride/(meth)acryloyloxyethyldimethylhexadecylammonium chloride copolymer (cf. European patent application EP-A-657 478). In the latter case, it is disclosed that the associative nature can be provided by the alkyl chains of the (meth)acryloyloxyethyldimethylhexadecylammonium chloride. The synthesis of this dispersant is carried out in an aqueous medium, thus making possible only the use of the second comonomer, which admittedly is less hydrophilic than diallyldimethylammonium chloride, but has to be water-soluble. This point places a considerable limitation on the hydrophobic nature of these dispersing copolymers. It is important to specify that an increase in the hydrophobic nature should make it possible to obtain a dispersion of improved fluidity.

As regards the precipitated polymer to be stabilized, cationic or amphoteric copolymers are obtained by polymerizing a mixture of water-soluble monomers in the presence of dispersant, of water and of salts. As the copolymer is insoluble in a saline aqueous medium, polymer particles are formed by precipitation because of the reduction in the electrostatic repulsions of the polyelectrolyte of high molar mass. The typical monomer mixture for this type of polymerization is composed of (meth)acrylamide, of (meth)acryloxyethyldimethyltrimethylammonium chloride and (meth)acryloxyethyldimethyldimethylbenzylammonium chloride (U.S. Pat. No. 4,929,655). The latter plays an important role in the precipitation of the cationic polymer formed during synthesis and in the formation of particles. U.S. Pat. No. 5,587,415 shows that it is possible to dispense with this monomer by substituting it by another equivalent in which the benzyl group is replaced by a sufficiently hydrophobic C₄₋₁₀ alkyl chain. Likewise, U.S. Pat. No. 5,614,602 shows that the same results can be achieved by partially substituting the (meth)acrylamide by an N-alkylacrylamide or by an N,N-dialkylacrylamide. European patent application EP-A-0 717 056 claims dispersions of amphoteric water-soluble polymers based on cationic monomers, including (meth)acryloxyethyldimethyldimethylbenzylammonium chloride, and anionic monomers (acrylic acid), which dispersions are synthesized in the presence of dispersant.

The presence of salt in these dispersions contributes significantly to the production of fluid products. However, the salt can limit the use of these dispersions in certain applications (thickeners or agents which facilitate the cleaning of textiles, for example). German patent application DE-A-4 216 167 and U.S. Pat. No. 5,403,883 disclose a technique for producing salt-free dispersions of low viscosity by polymerization, in the presence of the poly(diallyldimethylammonium chloride) dispersant, of a mixture of hydrophilic, hydrophobic and optionally amphiphilic monomers. On the same basis, European patent application EP-A-0 670 333 discloses dispersions of crosslinked polymers obtained by adding a crosslinking agent, such as N-methylolacrylamide or N,N-methylenebisacrylamide, to the mixture of monomers to be polymerized. A postaddition of the same dispersant makes possible a decrease in the viscosity of the systems described above (Canadian patent No. 3 123 460). However, it has the effect of increasing the level of dispersant and of resulting in a dispersion which has a low level of dispersed polymer.

The prior state of the art shows that the viability of salt-free aqueous dispersions of water-soluble polymers, which are handicapped with respect to their salt-comprising homologs, is based on the proposal of solutions which make it possible to reduce the viscosity of the dispersions either by means of novel comonomers or by means of novel dispersants.

As indicated above, the Applicant Company has discovered cationic monomers which make it possible to prepare salt-free dispersions of water-soluble copolymers with improved properties, in this case of low viscosity.

A first subject matter of the present invention is therefore a salt-free aqueous dispersion of a water-soluble copolymer obtained from a monomer composition comprising, per 100 parts by moles:

(a) from 0.5 to 99.5 parts by moles of at least one monomer of formula (I):

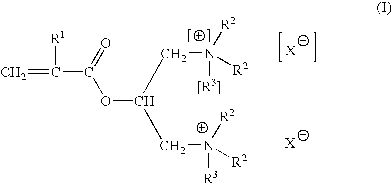

in which:

R¹ represents H or —CH₃;

R² represents —CH₃; —C₂H₅; —C₃H₇ or —C₄H₉; and

the compound (I) is optionally quaternized on one of the nitrogens, which is symbolized by the fact that the R³, X⁻ and ⁺ entities associated with this nitrogen are between square brackets;

when the compound (I) is quaternized on just one nitrogen, R³ and X⁻ have the following meanings:

(1) R³ represents —CH₂—C₆H₅; and X⁻ represents Cl⁻ or CH₃OSO₃⁻; or

(2) R³ represents —(CH₂)ₚCH₃ with p an integer from 3 to 11; and X⁻ represents Br⁻ or I⁻;

when the compound (I) is quaternized on both nitrogens, the two X⁻ entities can be identical or different and the two R³ entities can be identical or different, in which case:

(3) R³ represents —CH₂—C₆H₅; and X⁻ represents Cl⁻; or

(4) R³ represents —(CH₂)ₚCH₃ with p an integer from 3 to 11; and X⁻ represents Br⁻ or I⁻;

(5) among the compounds (I) quaternized on both nitrogens and having the two R³ entities different, if one of the R³ entities represents —CH₃, —C₂H₅ or —C₃H₇; and X⁻ represents Cl⁻ or CH₃OSO₃⁻, the other represents —CH₂C₆H₅, the associated X⁻ representing Cl⁻, or represents —(CH₂)ₚCH₃ with p an integer from 3 to 11, the associated X⁻ representing Br⁻ or I⁻;

(b) from 99.5 to 0.5 parts by moles of at least one water-soluble monomer chosen from:

those of formula (II):

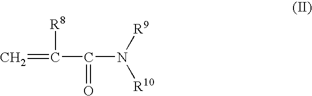

in which:

R⁸ represents H or —CH₃;

R⁹ and R¹⁰, which are identical or different, each independently represent H or C₁₋₅ alkyl;

those of formula (III):

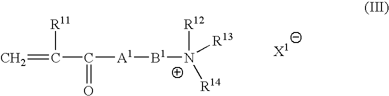

in which:

R¹¹ represents H or —CH₃;

A¹ represents —O— or —NH—;

B¹ represents —CH₂CH₂—, —CH₂CH₂CH₂— or —CH₂CHOHCH₂—;

R¹², R¹³ and R¹⁴ each independently represent hydrogen, C₁-C₆ alkyl, C₁-C₆ hydroxyalkyl, C₅-C₁₂ cycloalkyl, C₆-C₁₂ aryl or C₇-C₁₂ alkylaryl;

X¹⁻ represents a monovalent anion, such as Cl⁻, SCN⁻, CH₃SO₃⁻ and Br⁻;

carboxylic acids comprising ethylenic unsaturation, sulfuric acids comprising ethylenic unsaturation, sulfonic acids comprising ethylenic unsaturation, and their derivatives, such as, for example, the salts;

those of the formula (IV):

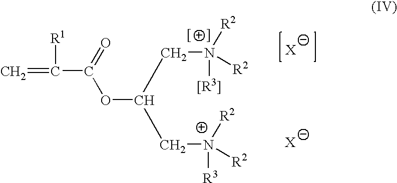

in which:

R¹ represents H or —CH₃;

R² represents —CH₃; —C₂H₅ or —C₃H₇; and

the compound (IV) is optionally quaternized on one of the nitrogens, which is symbolized by the fact that the R³, X⁻ and ⁺ entities associated with this nitrogen are between square brackets;

R³ represents —CH₃, —C₂H₅ or —C₃H₇; and

X⁻ represents Cl⁻ or CH₃OSO₃⁻; and

when the compound (IV) is quaternized on both nitrogens, the two X⁻ entities can be identical or different and the two R³ entities can be identical or different;

it being possible for said monomer composition to include, per 100 parts by moles of (a)+(b):

(c) up to 30 parts by moles of at least one hydrophobic monomer; and/or

(d) up to 10 parts by moles of at least one crosslinking monomer;

(e) up to 30 parts by moles of at least one amphiphilic monomer.

The preferred monomer of formula (I) is the compound of formula (Ia):

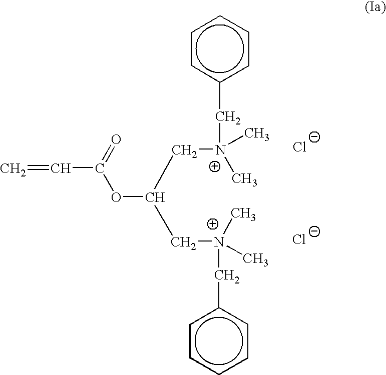

Mention may be made, as examples of monomers of formula (II), of acrylamide, N-methylacrylamide and N,N-dimethylacrylamide.

Mention may be made, as examples of monomers of formula (III), of (meth)acryloxyethyltrimethylammonium or (meth)acryloxyethyldimethylbenzylammonium halides (chlorides).

Mention may be made, as examples of carboxylic acids comprising ethylenic unsaturation, of (meth)acrylic acid and itaconic acid.

Mention may be made, as an example of monomer (b) of formula (I), of the compound of formula (Ib):

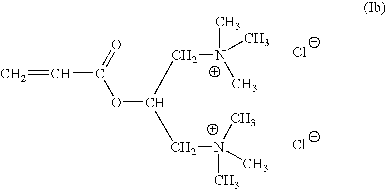

The monomers (c) can be chosen from:

those of formula (V):

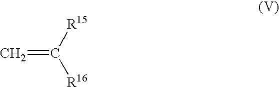

in which:

R¹⁵ and R¹⁶, which are identical or different, each represent H,

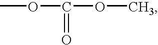

C₁₋₁₂ alkyl, C₅₋₁₂ cycloalkyl, C₆₋₁₂ aryl or C₈₋₃₂ arylalkyl;

those of formula (VI):

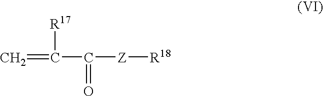

in which:

R¹⁷ represents H or CH₃;

Z represents —O— or —NH— or —NR¹⁹—, with R¹⁹ representing C₁₋₄ alkyl;

R¹⁸ represents C₁₋₃₂ alkyl, C₅₋₁₂ cycloalkyl, C₆₋₁₂ aryl or C₈₋₃₂ arylalkyl;

maleic anhydride;

vinylidene chloride;

vinylidene fluoride;

vinyl chloride; and

perfluorinated (meth)acrylic monomers.

Mention may be made, as examples of monomers of formula (V), of styrene and vinyl acetate and mention may be made, as examples of monomers of formula (VI), of butyl (meth)acrylate and methyl (meth)acrylate.

The monomers (d) can be chosen from:

monomers comprising a methylol functional group; and

monomers having at least two polymerizable unsaturations.

Mention may be made, as examples of monomers comprising a methylol functional group, of N-methylolacrylamide and mention may be made, as examples of monomers having at least two polymerizable unsaturations, of N,N-methylenebisacrylamide and ethylene glycol dimethacrylate.

The monomers (e) can be chosen from those of formula (VII):

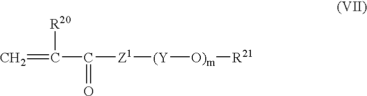

in which:

R²⁰ represents H or CH₃;

z¹ represents —O— or —NH— or —NR²²—, with R²² representing C₁₋₆ alkyl or C₁₋₆ hydroxyalkyl;

Y represents C₁₋₆ alkylene;

m is an integer of between 1 and 60;

R²¹ represents C₁₋₃₆ alkyl, C₆₋₅₀ aryl or C₆₋₅₆ aralkyl.

Mention may be made, as examples of monomers of formula (VII), of polyethoxylated (meth)acrylates with 10, 20 or 40 ethylene oxide units.

In accordance with a preferred embodiment of the dispersions according to the invention, the latter comprise:

(A) from 5 to 50 parts by weight, in particular from 10 to 30 parts by weight, of dispersed copolymer based on the composition of the abovementioned monomers (a) to (e); and

(B) from 0.5 to 25 parts by weight, in particular from 1 to 15 parts by weight, of at least one dispersing (co)polymer,

the remainder being composed of water.

The dispersing (co)polymer or (co)polymers (B) are chosen from cationic, amphoteric or nonionic (co)polymers with a molar mass of less than 600 000, in particular from 10 000 to 600 000, which are incompatible with the copolymer which it is desired to disperse (copolymer A). The two polymers (A) and (B) are regarded as incompatible when their mixture in an aqueous medium results, in a given composition range, in phase separation between the two polymers (A) and (B).

The following may be indicated as examples of dispersing (co)polymers (B):

poly(diallyldimethylammonium chloride);

poly((meth)acryloxyethyltrimethylammonium chloride);

copolymers based on diallyldimethylammonium chloride or on (meth)acryloxyethyltrimethylammonium chloride;

styrene-maleic anhydride copolymers which are imidized and quaternized by an alkyl chloride or benzyl chloride or by an acid;

poly(acrylamidopropylpropyltrimethylammonium chloride);

polyacrylamide;

poly(vinyl alcohol);

poly(ethylene oxide).

The preferred dispersants are:

cationic polymers based on styrene, on acryloxyethyltrimethylammonium chloride and on polyethoxy methacrylate, with or without a hydrophobic group, the latter being either the triphenylstyryl group or an alkyl chain;

amphoteric polymers based on styrene, on acryloxyethyltrimethylammonium chloride, on methacrylic acid and on polyethoxy methacrylate, with or without a hydrophobic group, the latter being either the triphenylstyryl group or an alkyl chain;

cationic polymers based on styrene, on diallyldimethylammonium chloride and on polyethoxy methacrylate, with or without a hydrophobic group, the latter being either the triphenylstyryl group or an alkyl chain;

cationic polymers based on styrene, on acryloxyethyltrimethylammonium chloride and on alkyl (meth)acrylate comprising a long C₁₂₋₃₀ chain; and

styrene-maleic anhydride copolymers which are imidized and quaternized with methyl chloride,

the polyethoxy methacrylate with a triphenylstyryl group, amphiphilic comonomer, being represented by the formula (VIII):

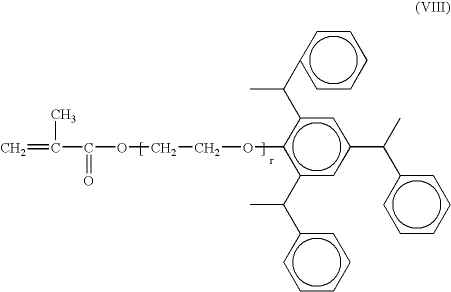

with r an integer from 1 to 60.

The present invention also relates to a process for the manufacture of an aqueous dispersion as defined above, characterized in that a radical polymerization in an aqueous medium of the monomer or monomers (a) to (e) as defined above is carried out in the presence of at least one polymer dispersant (B) as defined above.

The aqueous dispersion is prepared by using in particular:

from 5 to 50 parts by weight, in particular from 15 to 30 parts by weight, of the composition of the abovementioned monomers (a) to (e); and

from 0.5 to 25 parts by weight, in particular from 1 to 10 parts by weight, of the polymer dispersant or dispersants (B),

these parts being with respect to 100 parts by weight of the reaction mixture composed of water, the dispersing polymer or polymers (B) and the composition of the monomers (a) to (e).

The polymerization can be initiated by various means, such as free radical generators, for example peroxides, diazo compounds or persulfates, or by irradiation. The preferred form according to the invention is initiation by 2,2′-azobis(N,N′-dimethyleneisobutyramidine) dihydrochloride or 2,2′-azobis(2-aminopropane) hydrochloride. These initiators can be combined with a decomposition accelerator. The polymerization temperature is between −40° C. and 160° C., preferably being from 30 to 95° C. The conversion is greater than 99%.

The present invention also relates to the use of the dispersions of water-soluble copolymers as defined above or prepared by the process as defined above as flocculating agents for the treatment of waste water; agents for retaining fibers and fillers in processes for the manufacture of paper; agents facilitating the cleaning of supports, such as textiles; agents for dispersing fillers; inhibiting agents for the transfer of pigments and dyes onto various supports, such as textiles; thickeners; and dehydrating agents.

The examples which will follow, given by way of indication, make possible a better understanding of the invention. In these examples, the parts and percentages indicated are by weight, unless otherwise indicated, and the following abbreviations were used:

ADAME: dimethylaminoethyl acrylate

ADAMQUAT MC: acryloxyethyltrimethylammonium chloride

S-ADAME: (2-dimethylamino-1-dimethylaminomethyl)-ethyl acrylate:

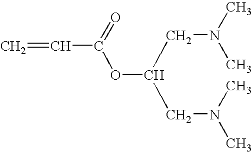

S-ADAMQUAT 2BZ: compound of the abovementioned formula (Ia)

SIPOMER SEM: polyethoxy methacrylate with a triphenylstyryl group, of formula:

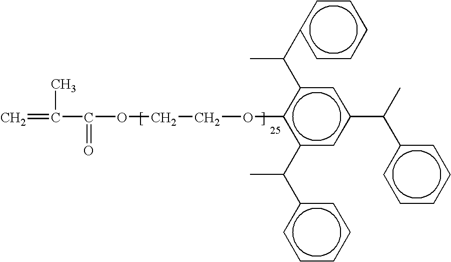

AMA: methacrylic acid

ABAH: 2,2′-azobis(2-aminopropane) hydrochloride

VA-044: 2,2′-azobis(N,N′-dimethyleneisobutyramidine) dihydrochloride

### EXAMPLE 1 (OF PREPARATION)

### (a) Synthesis of S-ADAME

The following are charged to a 1 liter glass reactor:

292 g of 1,3-bis(dimethylamino)-2-propanol;

242 g of triethylamine; and

0.373 g of phenothiazine, as stabilizer.

226 g of acrylic anhydride are added to this stirred mixture over 1 hour at ambient temperature while bubbling with air. The temperature increases to reach 50° C. After reacting for an additional 2 hours, the mixture is cooled and 50 ml of water are added. After separating by settling, an upper organic phase of 450 g is obtained and is distilled under reduced pressure to isolate 250 g of the title compound (GC purity≧99%).

### (b) Quaternization of S-ADAME to S-ADAMQUAT 2BZ

44.2 g of the S-ADAME obtained in point (a), stabilized with 1 500 ppm of hydroquinone methyl ether, and 150 g of CHCl₃ are charged to a 250 ml glass reactor. The mixture is brought to 50° C. with stirring and while bubbling with air. 55.9 g of benzyl chloride are added over 1 hour. After reacting for 25 hours, the starting acrylate has disappeared and 33 g of water are added. An upper phase is separated by settling and is freed from the traces of CHCl₃ by stripping with air at 45° C. under reduced pressure (P=1.33 ×10⁴ Pa) (100 mmHg)). 115.2 g of aqueous solution are thus obtained, which solution comprises 75% of quaternary cationic monomer having the expected structure, determined by ¹³C NMR. This monomer is known as S-ADAMQUAT 2BZ.

### EXAMPLE 2

### Preparation of a Dispersing Copolymer

The following are introduced with stirring into a 1 liter reactor:

703.3 parts of water;

36.83 parts of styrene;

339.4 parts of an 80% aqueous ADAMQUAT MC solution; and

33.6 parts of a commercial aqueous solution composed of SIPOMER SEM, AMA and water, in the proportions of 60% of SIPOMER SEM, 20% of AMA and 20% of water.

The reactor is brought to 70° C. while flushing with nitrogen and with stirring (150 rpm; anchor stirrer). When the temperature of the reaction medium has stabilized at 70° C., 0.2 part of ABAH is subsequently introduced. After reacting for 3 hours at 70° C., the temperature of the reaction medium is brought to 80° C. and 0.2 part of ABAH is introduced. After heating for 2 hours at 80° C., the reaction medium is cooled and a solution comprising 30.3% of water-soluble copolymer is recovered, the copolymer having the molar composition:

styrene/ADAMQUAT MC/SIPOMER SEM/AMA

19.23/76.25/0.67/3.84.

### EXAMPLE 3 (COMPARATIVE)

### Preparation of a Dispersion of Water-Soluble Copolymer, which Dispersion is Stabilized by the Dispersing Copolymer Obtained in Example 2

The following are introduced, with stirring, into a 1 liter reactor:

192 parts of water;

178 parts of the aqueous solution comprising 30.3% of water-soluble dispersing copolymer obtained in example 2;

67.5 parts of 50% acrylamide in water;

46.87 parts of an 80% aqueous ADAMQUAT MC solution;

3.75 parts of butyl acrylate; and

0.0055 part of ethylene glycol dimethacrylate.

The reactor is brought to 55° C., flushing with nitrogen is carried out for 1 hour and 0.0075 part of VA-044, diluted in 5 parts of water, is introduced. The temperature is maintained at 55° C. for 1 h 30. The reactor is heated to a temperature of 65° C. 0.075 part of VA-044, diluted in 5 parts of water, is subsequently added and the reaction is allowed to take place for an additional 2 hours at 65° C. The reactor is heated to a temperature of 80° C. and, after 1 hour, the reaction medium is cooled to 30° C. and the reactor is emptied.

A dispersion of acrylamide/ADAMQUAT MC/butyl acrylate/ethylene glycol dimethacrylate copolymer is obtained, which copolymer is stabilized by the copolymer dispersant of example 2 and has a Brookfield viscosity of 200 000 mPa.s (200 000 cP) at 25° C.

### EXAMPLE 4

### Preparation of a Dispersion of Water-Soluble Copolymer, which Dispersion is Stabilized by the Dispersing Copolymer of Example 2

The following are introduced, with stirring, into a 1 liter reactor:

190.75 parts of water;

178 parts of the aqueous solution comprising 30.3% of water-soluble dispersing copolymer obtained in example 2;

20 parts of the aqueous solution comprising 75% of S-ADAMQUAT 2BZ obtained in example 1;

67.5 parts of 50% acrylamide in water;

28.12 parts of an 80% aqueous ADAMQUAT MC solution;

3.75 parts of butyl acrylate; and

0.0055 part of ethylene glycol dimethacrylate.

The reactor is brought to 55° C., flushing with nitrogen is carried out for 1 hour and 0.0075 part of VA-044, diluted in 5 parts of water, is introduced. The temperature is maintained at 55° C. for 1 h 30. The reactor is heated to a temperature of 65° C. 0.075 part of VA-044, diluted in 5 parts of water, is subsequently added and the reaction is allowed to take place for an additional 2 hours at 65° C. The reactor is heated to a temperature of 80° C. and, after 1 hour, the reaction medium is cooled to 30° C. and the reactor is emptied.

A dispersion of acrylamide/S-ADAMQUAT 2BZ/ADAMQUAT MC/butyl acrylate/ethylene glycol dimethacrylate copolymer is obtained, which copolymer is stabilized by the copolymer dispersant of example 2 and has a Brookfield viscosity of 60 000 mPa.s (60 000 cP) at 25° C.

The incorporation of S-ADAMQUAT 2BZ in the composition of the dispersed polymer therefore has the effect of reducing the viscosity of the dispersion.

1. A salt-free aqueous dispersion of a water-soluble copolymer obtained from a monomer composition comprising, per 100 parts by moles:
(a) from 0.5 to 99.5 parts by moles of at least one monomer of formula (I): 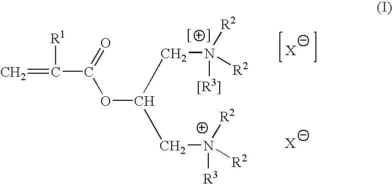
in which:
R¹ represents H or —CH₃;
R² represents —CH₃; —C₂H₅; —C₃H₇ or —C₄H₉; and
the compound (I) is optionally quaternized on one of the nitrogens, which is symbolized by the fact that the R³, X⁻ and ⁺ entities associated with this nitrogen are between square brackets;
when the compound (I) is quaternized on just one nitrogen, R³ and X⁻ have the following meanings:
(1) R³ represents —CH₂C₆H₅; and X⁻ represents Cl⁻ or CH₃OSO₃⁻; or
(2) R³ represents —(CH₂)ₚCH₃ with p an integer from 3 to 11; and X⁻ represents Br⁻ or I⁻;
when the compound (I) is quaternized on both nitrogens, the two X⁻ entities can be identical or different and the two R³ entities can be identical or different, in which case:
(3) R³ represents —CH₂—C₆H₅; and X⁻ represents Cl⁻; or
(4) R³ represents —(CH₂)ₚCH₃ with p an integer from 3 to 11; and X⁻ represents Br⁻ or I⁻;
(5) among the compounds (I) quaternized on both nitrogens and having the two R³ entities different, if one of the R³ entities represents —CH₃, —C₂H₅ or —C₃H₇; and X⁻ represents Cl⁻ or CH₃OSO₃⁻, the other represents —CH₂C₆H₅, the associated X⁻ representing Cl⁻, or represents —(CH₂)ₚCH₃ with p an integer from 3 to 11, the associated X⁻ representing Br⁻ or I⁻;
(b) from 99.5 to 0.5 parts by moles of at least one water-soluble monomer chosen from:
those of formula (II): 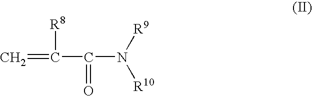
in which:
R⁸ represents H or —CH₃;
R⁹ and R¹⁰, which are identical or different, each independently represent H or C₁₋₅ alkyl;
those of formula (III): 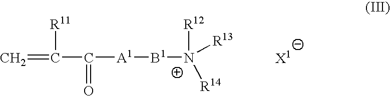
in which:
R¹¹ represents H or —CH₃;
A¹ represents —O— or —NH—;
B¹ represents —CH₂CH₂—, —CH₂CH₂CH₂— or —CH₂CHOHCH₂—;
R¹², R¹³ and R¹⁴ each independently represent hydrogen, C₁-C₆ alkyl, C₁-C₆ hydroxyalkyl, C₅-C₁₂ cycloalkyl, C₆-C₁₂ aryl or C₇-C₁₂ alkylaryl;
X¹⁻ represents a monovalent anion;
carboxylic acids comprising ethylenic unsaturation, sulfuric acids comprising ethylenic unsaturation, sulfonic acids comprising ethylenic unsaturation, and their derivatives;
those of the formula (IV): 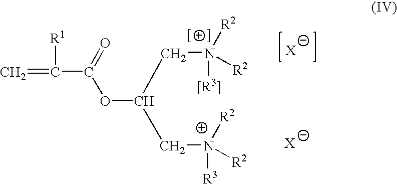
in which:
R¹ represents H or —CH₃;
R² represents —CH₃; —C₂H₅ or —C₃H₇; and
the compound (IV) is optionally quaternized on one of the nitrogens, which is symbolized by the fact that the R³, X⁻ and ⁺ entities associated with this nitrogen are between square brackets;
R³ represents —CH₃, —C₂H₅ or —C₃H₇; and
X⁻ represents Cl⁻ or CH₃OSO₃⁻; and
when the compound (IV) is quaternized on both nitrogens, the two X⁻ entities can be identical or different and the two R³ entities can be identical or different;
it being possible for said monomer composition to include, per 100 parts by moles of (a)+(b):
(c) up to 30 parts by moles of at least one hydrophobic monomer; and/or
(d) up to 10 parts by moles of at least one crosslinking monomer;
(e) up to 30 parts by moles of at least one amphiphilic monomer.

2. The aqueous dispersion as claimed in claim 1, characterized in that the compound (I) is that represented by the formula (Ia):

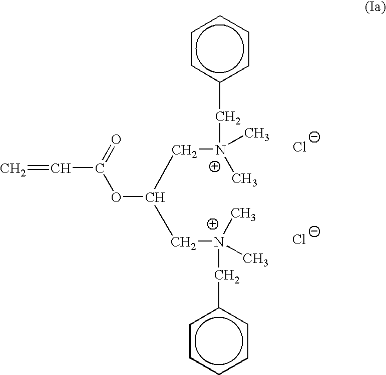

3. The aqueous dispersion as claimed in either of claims 1 and 2, characterized in that the monomers (c) are chosen from:
those of formula (V): 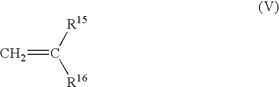
in which:
R¹⁵ and R¹⁶, which are identical or different, each represent H, 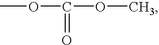
C₁₋₁₂ alkyl, C₅₋₁₂ cycloalkyl, C₆₋₁₂ aryl or C₈₋₃₂ arylalkyl;
those of formula (VI): 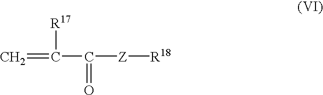
in which:
R¹⁷ represents H or CH₃;
Z represents —O— or —NH— or —NR¹⁹—, with R¹⁹ representing C₁₋₄ alkyl;
R¹⁸ represents C₁₋₃₂ alkyl, C₅₋₁₂ cycloalkyl, C₆₋₁₂ aryl or C₈₋₃₂ arylalkyl;
maleic anhydride;
vinylidene chloride;
vinylidene fluoride;
vinyl chloride; and
perfluorinated (meth)acrylic monomers.

4. The aqueous dispersion as claimed in one of claims 1 to 3, characterized in that the monomers (d) are chosen from:
monomers comprising a methylol functional group; and
monomers having at least two polymerizable unsaturations.

5. The aqueous dispersion as claimed in one of claims 1 to 4, characterized in that the monomers (e) are chosen from those of formula (VII): 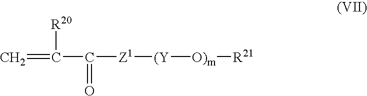
in which:
R²⁰ represents H or CH₃;
Z¹ represents —O— or —NH— or —NR²²—, with R²² representing C₁₋₆ alkyl or C₁₋₆ hydroxyalkyl;
Y represents C₁₋₆ alkylene;
m is an integer of between 1 and 60;
R²¹ represents C₁₋₃₆ alkyl, C₆₋₅₀ aryl or C₆₋₅₆ aralkyl.

6. The aqueous dispersion as claimed in one of claims 1 to 5, characterized in that it comprises, per 100 parts by weight:
(A) from 5 to 50 parts by weight of dispersed copolymer based on the composition of the monomers (a) to (e) as defined in one of claims 1 to 4; and
(B) from 0.5 to 25 parts by weight of at least one dispersing (co)polymer,
the remainder being composed of water.

7. The aqueous dispersion as claimed in claim 6, characterized in that it comprises:
(A) from 10 to 30 parts by weight of the dispersed copolymer; and
(B) from 1 to 15 parts by weight of the dispersing (co)polymer or (co)polymers,
the remainder being composed of water.

8. The dispersion as claimed in either of claims 6 and 7, characterized in that the dispersing (co)polymer or (co)polymers (B) are chosen from cationic, amphoteric or nonionic (co)polymers with a molecular mass of less than 600 000.

9. The dispersion as claimed in claim 8, characterized in that the dispersing (co)polymer or (co)polymers (B) are chosen from:
poly(diallyldimethylammonium chloride);
poly((meth)acryloxyethyltrimethylammonium chloride);
copolymers based on diallyldimethylammonium chloride or on (meth)acryloxyethyltrimethylammonium chloride;
styrene-maleic anhydride copolymers which are imidized and quaternized by an alkyl chloride or benzyl chloride or by an acid;
poly(acrylamidopropylpropyltrimethylammonium chloride);
polyacrylamide;
poly(vinyl alcohol); and
poly(ethylene oxide).

10. The dispersion as claimed in claim 9, characterized in that the dispersing (co)polymer or (co)polymers (B) are chosen from:
cationic polymers based on styrene, on acryloxyethyltrimethylammonium chloride and on polyethoxy methacrylate, with or without a hydrophobic group, the latter being either the triphenylstyryl group or an alkyl chain;
amphoteric polymers based on styrene, on acryloxyethyltrimethylammonium chloride, on methacrylic acid and on polyethoxy methacrylate, with or without a hydrophobic group, the latter being either the triphenylstyryl group or an alkyl chain;
cationic polymers based on styrene, on diallyldimethylammonium chloride and on polyethoxy methacrylate, with or without a hydrophobic group, the latter being either the triphenylstyryl group or an alkyl chain;
cationic polymers based on styrene, on acryloxyethyltrimethylammonium chloride and on alkyl (meth)acrylate comprising a long C₁₂-C₃₀ chain; and
styrene-maleic anhydride copolymers which are imidized and quaternized with methyl chloride,
the polyethoxy methacrylate with a triphenylstyryl group being represented by the formula (VIII): 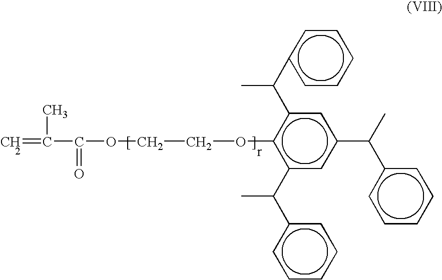
with r an integer from 1 to 60.

11. A process for the manufacture of the aqueous dispersion as defined in one of claims 1 to 10, characterized in that the radical polymerization in an aqueous medium of the monomer or monomers (a) to (e) as defined in one of claims 1 to 5 is carried out in the presence of at least one polymer dispersant (B) as defined in one of claims 6 to 10.

12. The process as claimed in claim 11, characterized in that the aqueous dispersion is prepared by using:
from 5 to 50 parts by weight of the composition of the water-soluble monomers (a) to (e); and
from 0.5 to 25 parts by weight of the polymer dispersant or dispersants (B), these parts being with respect to 100 parts by weight of the reaction mixture composed of water, the dispersing polymer or polymers (B) and the composition of the monomers (a) to (e).

13. The process as claimed in claim 12, characterized in that the aqueous dispersion is prepared by using:
from 15 to 30 parts by weight of the composition of the water-soluble monomers (a) to (e); and
from 1 to 10 parts by weight of the polymer dispersant or dispersants (B),
these parts being with respect to 100 parts by weight of the reaction mixture composed of water, the dispersing polymer or polymers (B) and the composition of the monomers (a) to (e).

14. The process as claimed in one of claims 11 to 13, characterized in that it is carried out at a temperature of −40° C. to 160° C.

15. The process as claimed in claim 14, characterized in that it is carried out at a temperature of 30 to 95° C.

16. The use of the dispersion of water-soluble copolymers as defined in one of claims 1 to 11 or prepared by the process as defined in one of claims 12 to 15, as flocculating agent for the treatment of waste water; agent for retaining fibers and fillers in processes for the manufacture of paper; agent facilitating the cleaning of supports, such as textiles; agent for dispersing fillers; inhibiting agent for the transfer of pigments and dyes onto various supports, such as textiles; thickener; and dehydrating agent.
